(19) United States
(12) Patent Application Publication
(10) Pub. No.: US 2006/0277395 A1
(43) Pub. Date: Dec. 7, 2006

(54) Processor performance monitoring

(76) Inventor: Richard G. Fowles, Meadow Vista, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/145,601

(22) Filed: Jun. 6, 2005

(51) Int. Cl. G06F 9/44

(52) U.S. Cl. 712/227

(57) ABSTRACT

Systems, methods, and device are provided for monitoring a processor. One method embodiment includes selectively combining micro-architectural events into various groups of micro-architectural events. The method includes multiplexing the various groups of micro-architectural events to a performance monitoring unit (PMU) associated with the processor.

### BACKGROUND

Before a computing device may accomplish a desired task, it must receive an appropriate set of instructions. Executed by a device's processor(s), these instructions direct the operation of the device. These instructions can be stored in a memory of the computer. Instructions can invoke other instructions.

A computing device, such as a server, router, desktop computer, laptop, etc., and other devices having processor logic and memory, includes an operating system layer and an application layer to enable the device to perform various functions or roles. The operating system layer includes a “kernel”, i.e., master control program, that runs the computing device. The kernel provides task management, device management, and data management, among others. The kernel sets the standards for application programs that run on the computing device and controls resources used by application programs. The application layer includes programs, i.e., executable instructions, which are located above the operating system layer and accessible by a user. As used herein, “user space”, “user-mode”, or “application space” implies a layer of code which is less privileged and more directly accessible by users than the layer of code which is in the operating system layer or “kernel” space.

With software optimization as a major goal, monitoring and improving software execution performance on various hardware is of interest to hardware and software developers. Some families of processors include performance monitoring units (PMUs) that can monitor up to several hundred or more micro-architecture events. For example, Intel's® Itanium® family of processors have anywhere from 400 to 600 low level micro-architecture events that can be monitored by the PMU. However, these events are so low level that it is not possible for a normal user to gleam any insight as to the causes of poor processor execution performance. This is compounded by the fact that producing any high-level performance metric involves the simultaneous monitoring of more events than there are counters available in the PMU.

### BRIEF DESCRIPTION OF THE DRAWINGS

FIG. 1 is a block diagram of a computer system suitable to implement embodiments of the invention.

FIG. 2 is an embodiment illustrating multiplexing groups of micro-architecture events to a performance monitoring unit on a processor.

FIG. 3 is a block diagram illustrating a method embodiment according to the present invention.

FIG. 4 illustrates a more detailed flow chart of various method embodiments for measuring different groups of micro-architecture events according to a distribution tree.

FIGS. 5A-5B illustrate an embodiment of a distribution tree including groups of micro-architecture events which can be multiplexed, measured, and provide metrics according to various program embodiments.

FIG. 6 is a normalized graph illustrates cross correlation of different measurements, with their respective number of different groups of micro-architecture events, and correlation between samples in real time.

### DETAILED DESCRIPTION

Systems, methods, and device are provided for monitoring a processor. One method embodiment includes selectively combining micro-architectural events into various groups of micro-architectural events. The method includes multiplexing the various groups of micro-architectural events to a performance monitoring unit (PMU) associated with the processor. According to various embodiments data representing counts for the various micro-architectural events are recorded and metrics are calculated from the recorded data by combining the various groups based upon particular relationship distribution trees.

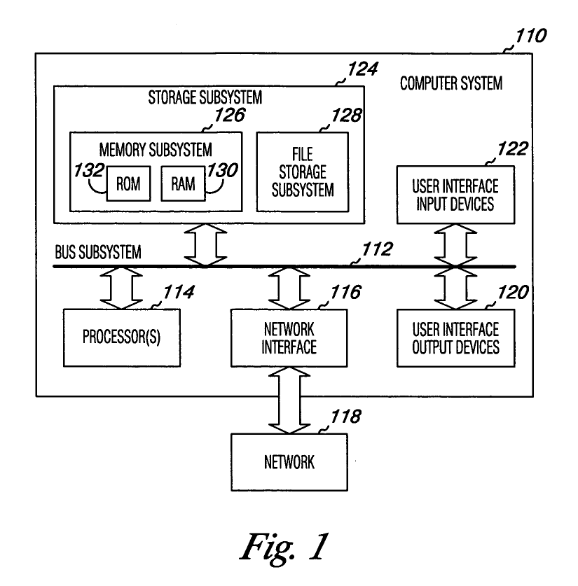

FIG. 1 is a block diagram of a computer system 110 suitable to implement embodiments of the invention. Computer system 110 includes at least one processor 114 which communicates with a number of other computing components via bus subsystem 112. These other computing components may include a storage subsystem 124 having a memory subsystem 126 and a file storage subsystem 128, user interface input devices 122, user interface output devices 120, and a network interface subsystem 116, to name a few. The input and output devices allow user interaction with computer system 110. Network interface subsystem 116 provides an interface to outside networks, including an interface to network 118 (e.g., a local area network (LAN), wide area network (WAN), Internet, and/or wireless network, among others), and is coupled via network 118 to corresponding interface devices in other computer systems. Network 118 may itself be comprised of many interconnected computer systems and communication links, as the same are known and understood by one of ordinary skill in the art. Communication links as used herein may be hardwire links, optical links, satellite or other wireless communications links, wave propagation links, or any other mechanisms for communication of information.

User interface input devices 122 may include a keyboard, pointing devices such as a mouse, trackball, touchpad, or graphics tablet, a scanner, a touchscreen incorporated into a display, audio input devices such as voice recognition systems, microphones, and other types of input devices. In general, use of the term “input device” is intended to include all possible types of devices and ways to input information into computer system 110 or onto computer network 118.

User interface output devices 120 may include a display subsystem, a printer, a fax machine, or non-visual displays such as audio output devices. The display subsystem may be a cathode ray tube (CRT), a flat-panel device such as a liquid crystal display (LCD) and/or plasma display, or a projection device (e.g., a digital light processing (DLP) device among others). The display subsystem may also provide non-visual display such as via audio output devices. In general, use of the term “output device” is intended to include all possible types of devices and ways to output information from computer system 110 to a user or to another machine or computer system 110.

Storage subsystem 124 can include the operating system “kernel” layer and an application layer to enable the device to perform various functions, tasks, or roles. File storage subsystem 128 can provide persistent (non-volatile) storage for additional program and data files, and may include a hard disk drive, a floppy disk drive along with associated removable media, a compact digital read only memory (CD-ROM) drive, an optical drive, or removable media cartridges. Memory subsystem 126 typically includes a number of memories including a main random access memory (RAM) 130 for storage of program instructions and data, e.g., application programs, during program execution and a read only memory (ROM) 132 in which fixed instructions, e.g., operating system and associated kernel, are stored. As used herein, a computer readable medium is intended to include the types of memory described above. Program embodiments as will be described further herein can be included with a computer readable medium and may also be provided using a carrier wave over a communications network such as the Internet, among others. Bus subsystem 112 provides a mechanism for letting the various components and subsystems of computer system 110 communicate with each other as intended.

Program embodiments according to the present invention can be stored in the memory subsystem 126, the file storage subsystem 128, and/or elsewhere in a distributed computing environment as the same will be known and understood by one of ordinary skill in the art. Due to the ever-changing nature of computers and networks, the description of computer system 110 depicted in FIG. 1 is intended only as one example of a computing environment suitable for implementing embodiments of the present invention. Many other configurations of computer system 110 are possible having more or less components than the computer system depicted in FIG. 1.

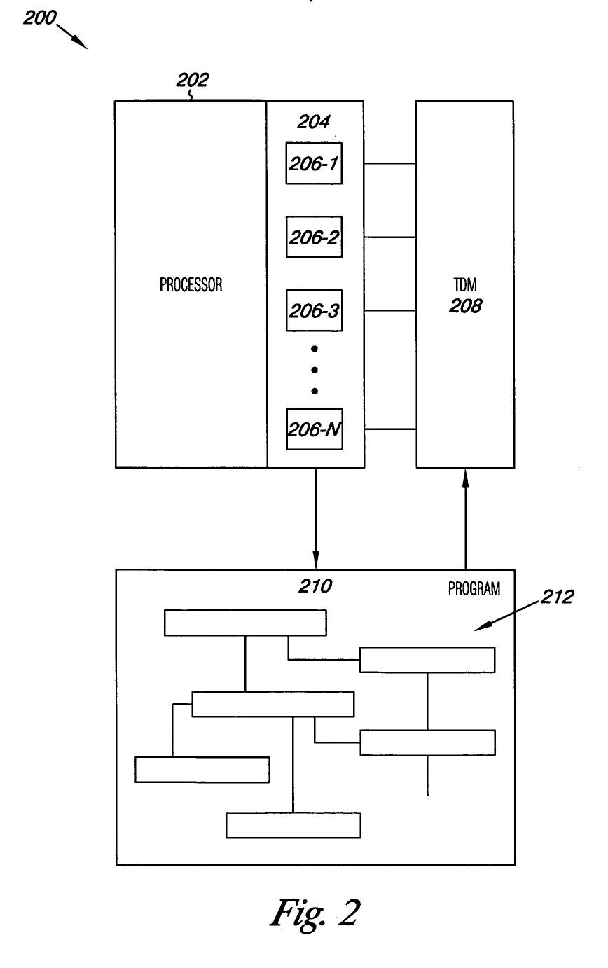

FIG. 2 is an embodiment illustrating multiplexing groups of micro-architecture events to a performance monitoring unit on a processor. As shown in the embodiment of FIG. 2 a processor 202 includes a performance monitoring unit (PMU) 204. As described above, some families of processors include performance monitoring units (PMUs) that can monitor up to several hundred or more micro-architecture events. For example, Intel's® Itanium® family of processors have anywhere from 400 to 600 low level micro-architecture events that can be monitored by the PMU. As shown in FIG. 2, the PMU 204 is illustrated having a number of PMU configuration sets, 206-1, 206-2, 206-3, . . . , 206-N. The designator “N” is used to indicate that a number of PMU configuration sets, 206-1, 206-2, 206-3, . . . , 206-N, can be included with a given PMU 204. A given PMU configuration set, e.g., 206-1, will have one or more associated counters, registers, opcode, iaddresses, daddresses, constants, etc. As the reader will appreciate, a performance monitoring application in the application layer, or “user space” uses the OS code to allow access to data collected by the performance monitoring application according to services rendered by the OS.

As described above, the PMU's, e.g., 204, of some processors, e.g., 202, allow for anywhere from 400 to 600 low level micro-architecture events to be monitored. However, these events are so low level that previous performance monitoring application did not make it possible for a normal user to gleam any insight as to the causes of poor processor execution performance. This fact is compounded by the fact that producing any high-level performance metric involves the simultaneous monitoring of more events than there are counters available or involves more qualification resources (e.g., opcode matching, instruction address range limits or data address range limits) than are available in the PMU 204.

According to the present embodiments, and as illustrated in the embodiment of FIG. 2, a monitoring program application 210 is provided to the application layer of a given computing device. The program 210 includes instructions that execute to configure the PMU configuration sets, 206-1, . . . , 206-N, to monitor various groups of micro-architectural events having selected combinations according to defined relationship distribution trees 212. The program instructions execute in cooperation with a multiplexor 208 to multiplex the various groups of micro-architectural events to the PMU configuration sets, 206-1, . . . , 206-N, and to load measurement context definitions thereon. The program instructions execute to read and store the measured data from counters associated with the PMU configuration sets, 206-1, . . . , 206-N. According to various embodiments the multiplexor 208 can time division multiplex selective combinations of PMU micro-architecture event to the PMU configuration sets, 206-1, . . . , 206-N, using timed gating of each event set, by counter overflow generated event switching or by some multiplexing scheme provided by the operating system.

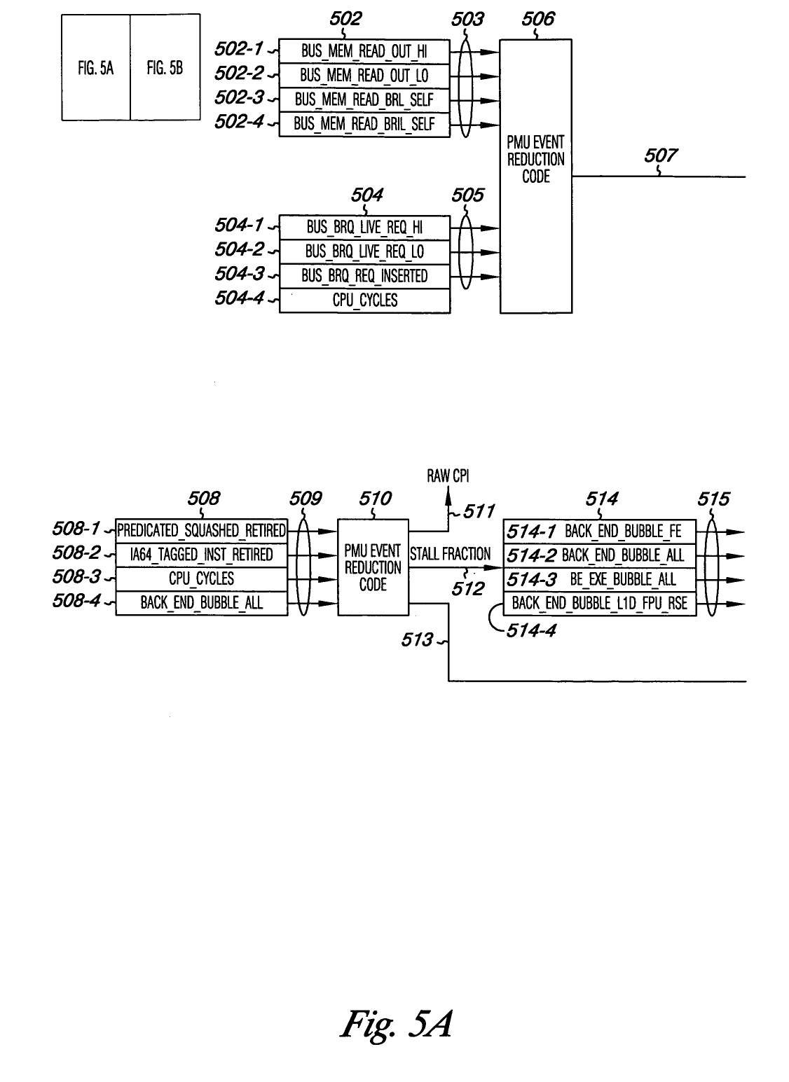

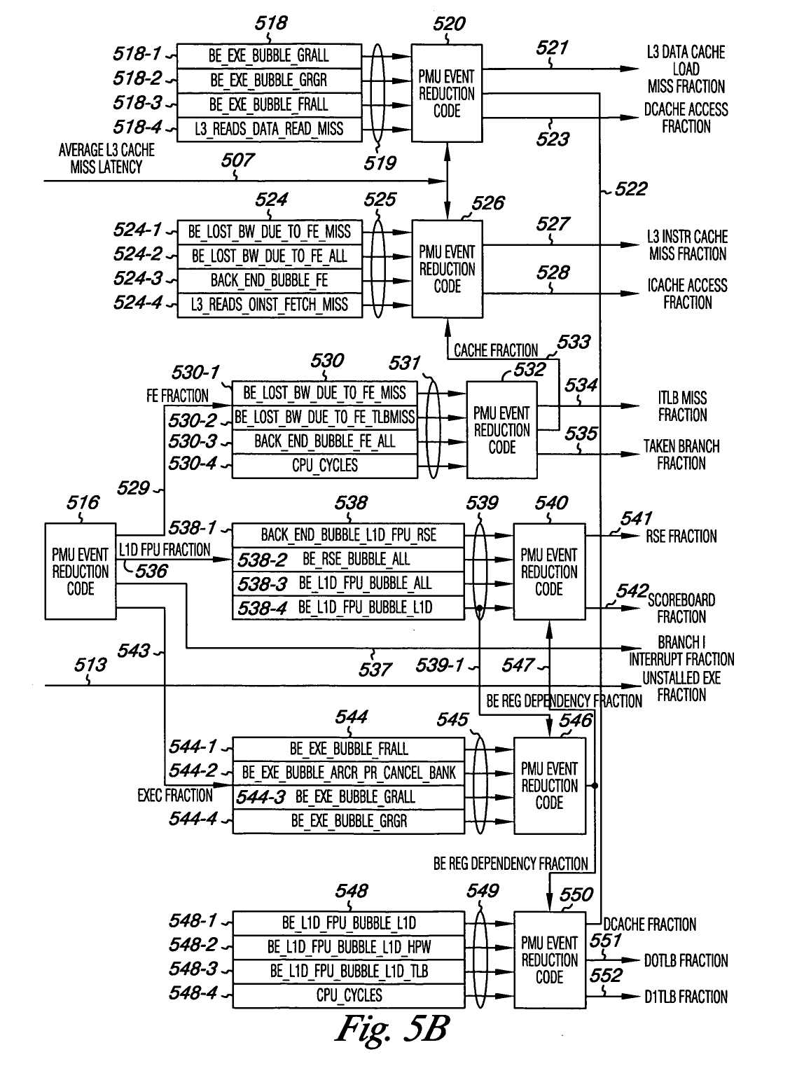

According to various embodiments the program instructions can further execute to calculate metrics from the PMU data according to event relationship distribution trees 212 that are used to produce a number of derived performance metric that a particular user may wish to monitor. For example, the instructions can execute to combine data from selective combinations of PMU micro-architecture events based upon a distribution tree relationship in order to produce a prioritized accounting of the reasons for processor execution stalls. As the reader will appreciate in more detail below, the program embodiments described herein afford the advantage of monitoring in real time the reasons for inefficient processor execution, thus allowing the distinct execution phases of running program applications to be fully characterized. A benefit of the real time monitoring capability is in allowing for the rapid and unambiguous characterization of finite execution time programs as well as non-terminating applications as is normally found in database oriented commercial applications. As such, a prioritized execution stall breakdown can be produced in a matter of minutes that clearly and unambiguously identifies the areas to focus efforts for improving performance. This is particularly valuable for commercial applications. By use of the relationship distribution trees, e.g., shown in FIGS. 5A-5B, it is possible to generate high level performance metrics of arbitrary complexity at a real time rate that yields the same result as a PMU that had an unlimited number of event count and qualification resources.

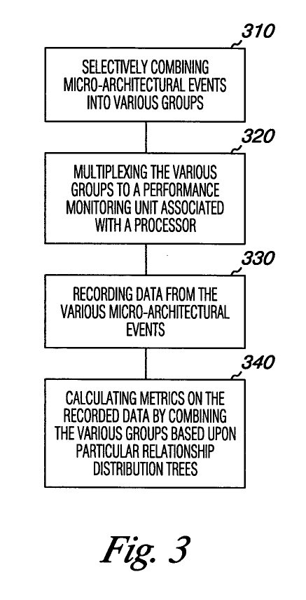

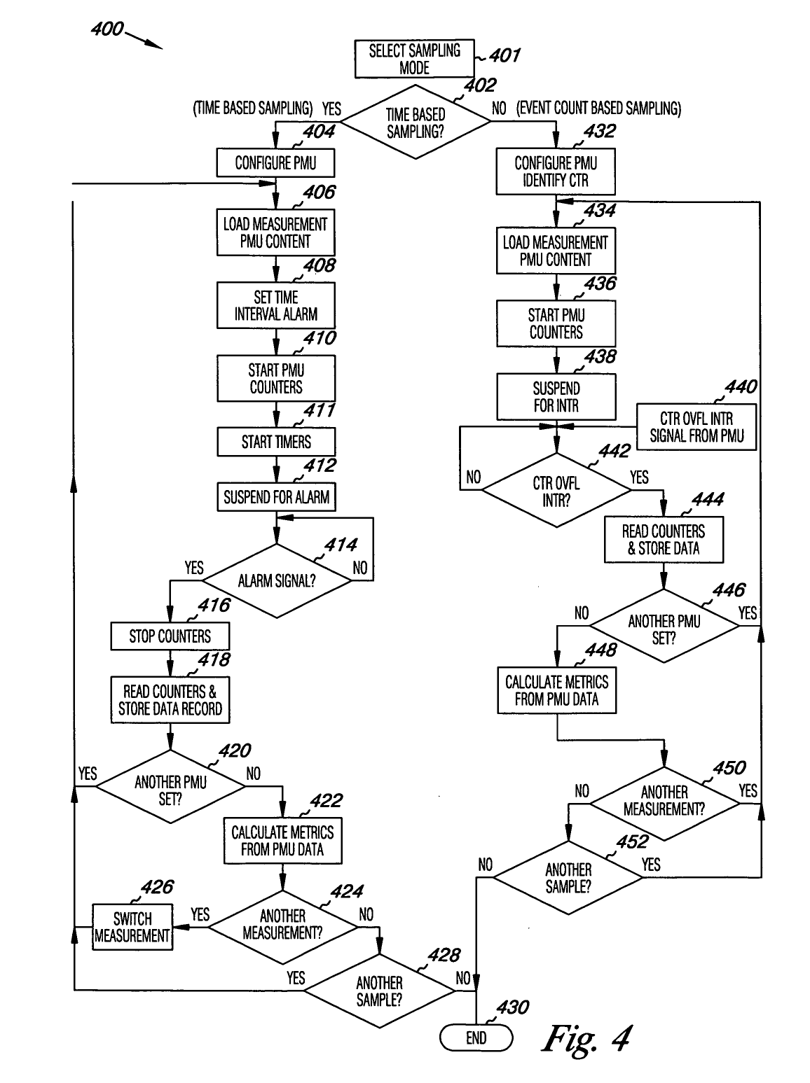

FIG. 3 illustrates a flow chart of a method embodiment according to the teachings of the present invention. As shown in FIG. 3, the method includes selectively combining micro-architectural events into various groups of micro-architectural events, e.g. performance monitoring unit (PMU) context definition sets, as shown at 310. Examples of various micro-architectural events combined into different groups, e.g., PMU context definition sets, are illustrated in more detail in FIGS. 5A-5B. At 320, the method includes multiplexing the various groups of micro-architectural events, e.g., PMU context definition sets, to a performance monitoring unit (PMU) associated with the processor, as shown in FIG. 2 and discussed further in FIG. 4.

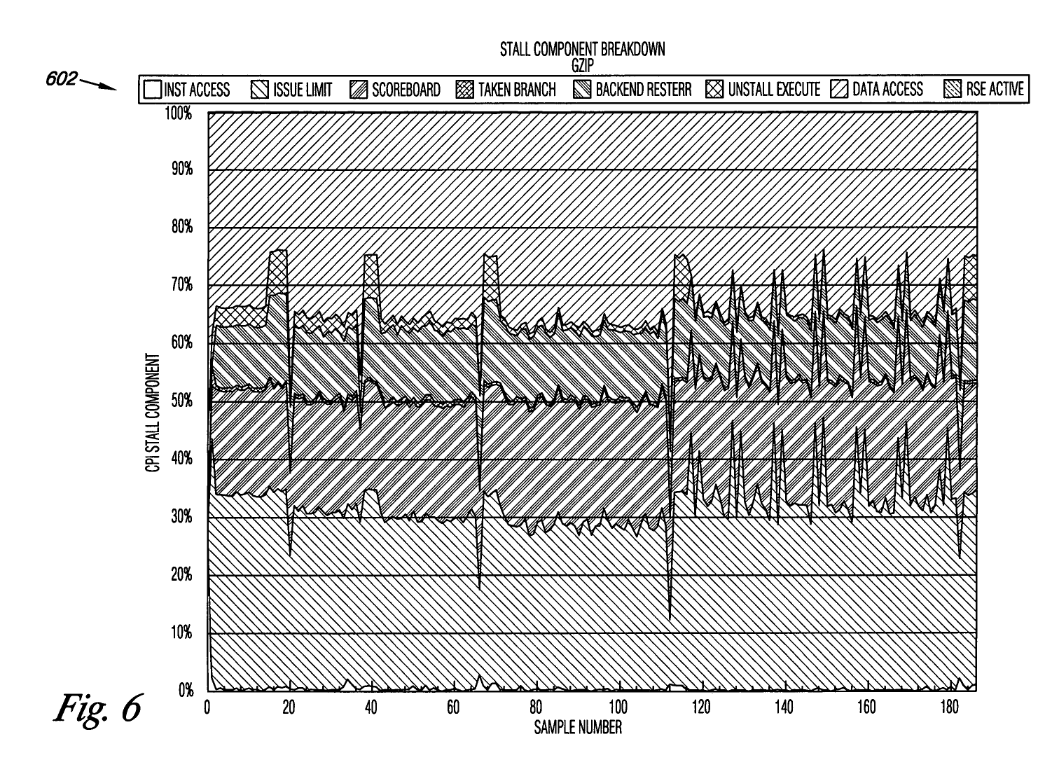

At 330, the method includes recording data from the various micro-architectural events. At 340 the method includes calculating metrics on the recorded data by combining the various groups based upon particular relationship distribution trees. An example of calculating metrics on the recorded data by combining the various groups of micro-architectural events based upon particular relationship distribution trees is illustrated in more detail in FIGS. 5A-5B. According to various embodiments, different measurements, each having a number of different groups of micro-architecture events, can be cross correlated into a particular sample and displayed in real time, as shown in FIG. 6. And, according to various embodiments, different samples can be cross-correlated as well.

FIG. 4 illustrates a more detailed flow chart according to various operational method embodiments. FIG. 4 is a flow chart of various method embodiments for measuring different groups of micro-architecture events according to a distribution tree. In FIG. 4 the method can begin with selecting a sampling mode 401, e.g., time based sampling or event count based sampling. As shown at decision block 402 a decision can be made to perform time based sampling or event count based sampling. One of ordinary skill in the art will recognize that the time based sampling may use wall clock time, process time, or processor time. As the reader will appreciated, a default selection can be implemented, which can be overridden by user input in the form of a command line instruction.

If the time based sampling mode is chosen the method proceeds to block 404 where the program instructions execute to configure a PMU, e.g., 204 in FIG. 2, based on a group having a selected combination of micro-architectural events to monitor according to a distribution tree (shown in more detail in FIGS. 5A-5B). At block 404, program instructions execute to configure the PMU and bind the monitoring program application to the operating system (OS) code. During PMU configuration the program instructions execute to inform the operating system of the sampling mode, configure the PMU configuration sets with their associated sets of counters, e.g., 206-1, . . . , 206-N in FIG. 2, including changing qualifiers for opcode matching, instruction address range count limits, data address range count limits, constants, etc., as the same will be appreciated by one of ordinary skill in the art. The OS is informed of whether process or processor (e.g., system) time will be used for the generation of the sample interval. In the case of process monitoring the PMU registers become part of the process save state.

At block 406, the program instructions execute to load measurement PMU context. This includes the particular context definitions for the selected group of micro-architectural events (described in more detail in FIGS. 5A-5B) to be measured. At block 408 the program instructions execute to set time interval alarm which determines the time interval to be used in performing the measurements. The time interval can be provided in the instructions based on the type and number of micro-architectural events, as well as the number of groups of combined micro-architectural events to be monitored. For example, if the instructions indicate the time interval to be a period of one second (1 sec), and ten (10) groups are to be measured, then the alarm interval would be (1 second/10 groups), or 100 millisecond (ms).

At block 410 the program instructions execute to start PMU counters 410. At block 411 the program instructions execute to start the timers and then at block 412 the monitoring program application can suspend (e.g., cease execution to prevent measurement contamination) until an alarm signal is received (shown at decision block 414) indicating that the time interval has expired. As shown at 414 if no alarm signal has been received the counters will continue counting this group of micro-architectural events. Once, however, an alarm signal is received the monitoring program application will wake up and program instructions will execute to stop the counters as shown at block 416. That is, when the time interval has expired the OS signals that a sample is available.

As shown at block 418, program instructions execute to read the counts associated with the various micro-architecture events that have been measured and to store the count information as data in memory. As shown at block 420 the program instructions execute to determine whether another group having a selected combination of micro-architectural events, e.g., PMU definition context set, is to be loaded to the PMU configuration sets, e.g., 206-1, . . . , 206-N, for measurement. FIGS. 5A-5B describe in more detail various example embodiments of groups of micro-architectural events that measured according to program embodiments described herein. As shown at 420, if the program instructions determine that another group, i.e., set, of micro-architecture events are to be measured the program instructions execute to load the appropriate measurement PMU context as described in connection with block 406. The program instructions then execute to repeat the sequence described in connection with blocks 406-420. As described above, loading measurement PMU context includes loading the context definitions to the PMU. As the reader will appreciate the PMU context definitions, examples of which are illustrated in FIGS. 5A-5B, define for the PMU what is to be measured.

As shown in block 420, if the program instructions determine that another set of micro-architecture events are not remaining in the present measurement routine the program instructions execute calculate metrics from the collected count information as shown at block 422. Again, one example embodiment for calculating metrics from the PMU data according to program embodiments is described in connection with FIGS. 4A-4B. As the reader will appreciate these metric are generated by instructions executing according to one or more distribution trees defined by the program embodiments described herein.

At block 424 the program instructions execute to determine if another measurement, with respective groups of micro-architectures events, is to be performed. If the program instructions determine that another measurement is to be performed the program instructions execute to switch the measurement as shown in block 426. As the reader will appreciate from this disclosure, switching the measurement 426 can include accessing a different distribution tree, according to program embodiments, having different respective groups of micro-architecture events to be measured. The program instructions then execute to load the appropriate measurement PMU context as described in connection with block 406. The program instructions then execute to repeat the sequence described in connection with blocks 406-420 to multiplex the measurement of different groups of micro-architectural events. Once the various sets of micro-architecture events have been measured, e.g., in multiplexed fashion, for this measurement the program instructions execute to again calculate metrics from the collected count information according to one or more distribution trees as shown at block 422, as defined by the program embodiments described herein.

Again, at block 424 the program instructions execute to determine if another measurement, with respective groups of micro-architectures events, is to be performed. If the program instructions determine that another measurement is to be performed the program instructions execute to switch the measurement as shown in block 426. If the program instructions execute to determine that another measurement is not to be performed the program instructions will execute to determine whether another sample is desired as shown at block 428.

As shown at decision tree 428, if another sample is desired then the program instructions execute to repeat the sequence described in connection with blocks 406-426 to multiplex the measurement of different groups of micro-architectural events. If, however, another sample is not desired the program ends as shown at 430.

As shown in FIG. 4, if an event count based sampling is chosen the method proceeds to block 432 where the program instructions execute to configure a PMU as described at block 404. However, in event count based sampling the PMU is additionally configured to identify which counter will serve as an overflow counter. At block 432, program instructions execute to configure the PMU and bind the monitoring program application, in user space, to the operating system (OS) code, in kernel space. During PMU configuration the program instructions will again execute to inform the operating system of the sampling mode, configure the PMU configuration sets with their associated sets of counters, e.g., 106-1, . . . , 106-N in FIG. 1, including changing opcode matcher, instruction address range limits, data address range limits, constants, etc., as described above.

At block 434, the program instructions execute to load measurement PMU context. This includes the particular context definitions for the selected groups of micro-architectural events (e.g., described in FIGS. 5A-5B) to be measured. According to embodiments, various distribution trees are defined in the program instructions of the monitoring program application in user space in order to multiplex various groups of defined combinations of micro-architectural events to monitor. In this manner, a finite number of counters can be used to measure a larger number of micro-architectural events than the number of counters available with the PMU. As the reader will appreciate, in this method embodiment one of the counters is used as the overflow counter for the event based sampling. At 432 this particular counter, e.g., used to generate the gating interval is identified to the OS so that it can associate and interrupt with a signal.

At block 436 program instructions execute to start the PMU counters and as shown at block 438, monitoring program application can suspend (e.g., cease execution to prevent measurement contamination) until a counter overflow interrupt signal is received. As shown at 442 if no counter overflow interrupt has been received the counters will continue counting the group of micro-architectural events. When the specified counter overflows an interrupt is sent to the OS and the PMU counters are halted. The OS in turn signals the application that a sample is available. That is, once a counter overflow interrupt signal is received the monitoring program application will wake up. As shown at block 444 the program instructions will execute to read the counters associated with the various micro-architecture events that have been measured and to store the count information associated with these respective micro-architecture events as data in memory.

As shown at decision tree 446 the program instructions execute to determine whether another group having a selected combination of micro-architectural events is to be measured. FIGS. 5A-5B describe various example embodiments of groups of micro-architectural events (i.e., PMU context definition sets) that can be measured according to program embodiments described herein. As shown at 446, if the program instructions determine that another group, i.e., set, of micro-architecture events are to be measured the program instructions execute to load the appropriate measurement PMU context as described in connection with block 434. The program instructions then execute to repeat the sequence described in connection with blocks 434-446. As described above, loading measurement PMU context includes loading the context definitions to the PMU.

As shown in block 452, if the program instructions determine that another set of micro-architecture events are not remaining in the present measurement routine the program instructions execute calculate metrics from the collected count information as shown at block 448. FIGS. 5A-5B will illustrate one example embodiment for calculating metrics from the PMU data according to various program embodiments. The metrics are generated by instructions executing according to one or more distribution trees defined by the various program embodiments and described in FIGS. 5A-5B.

At block 450 the program instructions execute to determine if another measurement, with respective groups of micro-architectures events, is to be performed. If the program instructions determine that another measurement is to be performed the program instructions execute to switch the measurement. As was described with block 426, switching the measurement includes accessing a different distribution tree having different respective groups of micro-architecture events to be measured. The program instructions then execute to load the appropriate measurement PMU context as described in connection with block 434 and to repeat the sequence described in connection with blocks 434-446 to multiplex the measurement of different groups of micro-architectural events to the PMU. Once the various sets of micro-architecture events have been measured, e.g., in multiplexed fashion, for this measurement the program instructions execute to again calculate metrics from the collected count information according to one or more distribution trees as shown at block 448, as defined by the program embodiments described more with FIGS. 5A-5B.

Again, at block 450 the program instructions execute to determine if another measurement, with respective groups of micro-architectures events, is to be performed. Once again, if the program instructions determine that another measurement is to be performed the program instructions execute to switch the measurement. However, if the program instructions execute to determine that another measurement is not to be performed the program instructions will execute to determine whether another sample is desired as shown at block 452.

As shown at decision tree 452, if another sample is desired then the program instructions execute to repeat the sequence described in connection with blocks 434-452 to multiplex the measurement of different groups of micro-architectural events. If, however, another sample is not desired the program ends as shown at 430.

FIGS. 5A-5B illustrate an embodiment of a distribution tree including groups of micro-architecture events which can be multiplexed, measured, and provide metrics according to various program embodiments. In the example illustration of FIGS. 5A-5B, embodiments are discussed in reference to performing an analysis, e.g., breakdown measurement, of a processor having a PMU with four available counters, e.g., an Itanium® processor available from Intel®. The example embodiments are further discussed with regards to a cycles per instruction (CPI) component breakdown measurement, e.g., in reference to a breakdown of the stalling CPI component into its components. With the Itanium® processor the CPI component can be divided into several components, as the same will be appreciated by one of ordinary skill in the art.

Micro-architecture event counts associated with these various components can be used to provide an idea of processor performance limiters. The micro-architecture event counts associated with these various components can further be analyzed in relation to several broad associations. That is, for the Itanium® processor example, various micro-architecture event counts can be combined into counts relating to the categories of scoreboard, data access (including D0TLB, D1TLB, DCACHE), instruction access (including ITLB and ICACHE), miss predicted branch, branch execution, RSE active, and unstalled execution (the period during which the processor is doing useful work). Each of these involves counting and combining data relating to various micro-architectural events.

By way of example, and not by way of limitation, scoreboard counts stall cycles due to dependencies on integer or floating point operations, floating point flushes, and control or application register read or writes. D1TLB counts the number of cycles stalled due to a level 0 data tlb miss that hits in the level 1 data tlb. D1TLB counts the number of cycles stalled due to a level 1 data miss during the time the hardware page walker (HPW) is actively attempting to resolve the requested tlb entry. DCACHE counts the number of cycles stalled due to data cache misses at any level of cache hierarchy (L1, L2, L3). Data access counts the number of cycles stalled due to data cache misses at any level of the cache hierarchy (L1, L2, L3) and data tlb misses at any level of the tlb hierarchy (L1, L2). ITLB counts the number of cycles where there are no backend stalls or pipeline flushes, the decoupling buffer is empty, the front end is stalled due to a L0 tlb miss, etc. ICACHE counts the number of cycles where there are no backend stalls or pipeline flushes, the front end is stalled due to an instruction cache miss, etc. Instruction access counts the number of cycles where there are no backend stalls or pipeline flushes, the decoupling buffer is empty, the front end is stalled due to an instruction cache miss or an instruction TLB miss. Backend flush counts the number of stall cycles resulting from a pipeline flush caused by a branch misprediction or an interrupt. Branch counts the number of stall cycles associated with branch execution. RSE active counts the number of cycles that the pipeline is stalled due to the register save engine spilling/filling registers to/from memory. And, unstalled execution counts the number of cycles that the backend is executing instructions, i.e., doing useful work on behalf of the currently executing application.

As shown in the embodiment of FIGS. 5A-5B, the program instructions execute to operate on a distribution tree that combines various micro-architecture events into groups each having four micro-architectural events as suitable for the four available counters in the Itanium® processor's PMU. The reader, however, will appreciate that the embodiments are not limited to the example given in FIGS. 5A-5B. Other example measurements that may be performed include miss rate measurements associated with the L1 instruction cache, L1 data cache, L2 unified cache, L3 unified cache, TLB, system bus utilization, instruction dispersal efficiency, branch path and target prediction effectiveness, etc.

In the embodiment of FIGS. 5A-5B, the CPI component breakdown measurement includes ten (10) PMU context definition sets, i.e., groups, shown as 502, 504, 508, 514, 518, 524, 530, 538, 544, and 548. Each of these make up a PMU context that is loaded to perform various measures, e.g., at blocks 306 and 434 in the flow chart of FIG. 4. In this example embodiment, each definition set is labeled with four micro-architectural events that will be loaded to the PMU configuration sets, e.g., 206-1, . . . , 206-N, in the multiplexed fashion described above in connection with FIGS. 2 and 3 for the four counters to monitor and count. The four micro-architectural events of each context definition set is numbered -1, -2, -3, -4, respectively. For example, context definition set 502, includes labeled micro-architecture definitions that are numbered as 502-1, 502-2, 502-3, and 502-4. One of skill in the art will appreciate the meaning of the labeled definition for each micro-architectural event in relationship to this Intanium® processor PMU example. As such, greater definition and explanation is not provided herein so as not to obscure the embodiments of the present invention.

As explained in connection with the embodiment of FIG. 4, when a particular measurement is chosen for sampling, e.g., breakdown of the stalling CPI component, the monitoring program application according to embodiments described herein will access and a number of different PMU context definition sets, e.g., 502, 504, 508, 514, 518, 524, 530, 538, 544, and 548, and implement them on the PMU configuration sets, e.g., load measurement PMU context 406 and 434 in FIG. 4, in a time division multiplexed manner. As shown in FIG. 4, the counts associated with the different PMU context definitions sets can be read and stored and then used to calculate metrics according to the program embodiments described herein. When the particular measurement is complete, a new measurement with its associated number of different PMU context definition sets can be accessed, multiplexed, and counted in turn.

FIGS. 5A-5B thus shown a number of different PMU context definitions sets which are time division multiplexed to the PMU configuration sets, e.g., 206-1, . . . , 206-N in FIG. 2, to obtain counts associated with the various groups of micro-architecture events, e.g., different PMU context definition sets, e.g., 502, 504, 508, 514, 518, 524, 530, 538, 544, and 548. Program instructions execute to read the counts of each of these different PMU context definition sets, e.g., 502, 504, 508, 514, 518, 524, 530, 538, 544, and 548, and calculate metrics according to a particular decision tree of the monitoring program application. In the example decision tree embodiment of FIGS. 5A-5B, the program instructions execute to combine the counts of each of these different PMU context definition sets, e.g., 502, 504, 508, 514, 518, 524, 530, 538, 544, and 548 as partial fractions to provide insight to various performance limiters.

Thus, in the example embodiment of FIGS. 5A-5B, the resultant count reads from the various multiplexed PMU context definition sets, e.g., 502, 504, 508, 514, 518, 524, 530, 538, 544, and 548 are combined as partial fractions to provided insight to produce category fractions relating to the categories of scoreboard, data access (including D0TLB, D1TLB, DCACHE), instruction access (including ITLB and ICACHE), miss predicted branch, branch execution, RSE active, and unstalled execution, mentioned above.

As shown in the embodiment of FIG. 5A, the partial fraction of micro-architectural event counts measured with PMU context definition set 502 are read and provided to 503 the program instructions to operate on as shown at 506. Similarly, in this embodiment, the partial fraction of micro-architectural event counts measured with PMU context definition set 504 are read and provided to 505 the program instructions to operate on as shown at 506. Here, the program instructions execute to combine the above described partial fractions and provide an output representing the “average L3 cache miss latency” at 507. Further in FIG. 5A the partial fraction of micro-architectural event counts measured with PMU context definition set 508 are read and provided to 509 the program instructions to operate on as shown at 510. Here, the program instructions execute to output raw CPI 511, a stall fraction 512, and an unstalled execution fraction 513.

As shown in the embodiment of FIG. 5A, the stall fraction 512 is further broken down into various sources based on the counts read in association with PMU context definition set 514. The counts of associated with sources of the stall fraction 512, e.g., the counts measured with PMU context definition set 514 are read and provided to 515 the program instructions to operate on as shown at 516.

Continuing in FIG. 5B, the partial fraction of micro-architectural event counts measured with PMU context definition set 518 are read and provided to 519 the program instructions to operate on as shown at 520. In FIG. 5B, the “average L3 cache miss latency” is also provided to 507 the program instructions to operate on as shown at 520. The program instructions execute to combine the above described partial fractions and provide outputs representing the “L3 data cache load miss fraction” at 521, and the “Dcache access fraction” at 523. As shown in this embodiment, a “Dcache fraction” is further provided to 522 program instructions to operate on as shown at 550 (discussed below).

In FIG. 5B, the partial fraction of micro-architectural event counts measured with PMU context definition set 524 are read and provided to 525 the program instructions to operate on as shown at 526. In FIG. 5B, the “average L3 cache miss latency” is also provided to 507 the program instructions to operate on as shown at 526. As shown in this embodiment, a “cache fraction” (discussed below) is further provided to 533 program instructions to operate on as shown at 526. The program instructions execute to combine the above described partial fractions and provide outputs representing the “L3 instruction cache miss fraction” at 527, and the “Icache access fraction” at 528.

As shown in FIG. 5B, the program instructions at 516 execute to combine the partial fractions of the micro-architectural count reads associated with PMU context definition set 514 (in FIG. 5A) and provide outputs representing “FE (front end) fraction” at 529, “L1D FPU fraction” at 536, “branch or interrupt fraction” at 537, and “exec fraction” at 543. As shown in the embodiment of FIG. 5B, the FE fraction 529 is further broken down into various sources based on the counts read in association with PMU context definition set 530. The counts associated with sources of the FE fraction 529, e.g., the counts measured with PMU context definition set 530 are read and provided to 531 the program instructions to operate on as shown at 532. The program instructions execute to combine the above described partial fractions and provide outputs representing the “ITLB miss fraction” at 534, and the “Taken branch fraction” at 535. As shown in FIG. 5B, a “cache fraction” output 533 is further provided to program instructions to operate on as shown at 526 (as mentioned above).

As shown in the embodiment of FIG. 5B, the LID FPU fraction 536 is further broken down into various sources based on the counts read in association with PMU context definition set 538. The counts of associated with sources of the LID FPU fraction 536, e.g., the counts measured with PMU context definition set 538 are read and provided to 539 the program instructions to operate on as shown at 540. The program instructions execute to combine the above described partial fractions and provide outputs representing the “RSE fraction” at 541, and the “scoreboard fraction” at 542. As shown in FIG. 5B, a “BE (backend) register dependency fraction” output 547 (discussed below) is further provided to program instructions to operate on as shown at 540. Further, in this embodiment, count 538-4 (BE_L1D_FPU_BUBBLE_L1D) measured with PMU context definition set 538 is read and provided to 539-1 the program instructions to operate on as shown at 546 (discussed below).

As shown in the embodiment of FIG. 5B, the exec fraction 543 is further broken down into various sources based on the counts read in association with PMU context definition set 544. The counts associated with sources of the exec fraction 543, e.g., the counts measured with PMU context definition set 544 are read and provided to 545 the program instructions to operate on as shown at 546. Count, 538-4 (BE_L1D_FPU_BUBBLE_L1D) measured with PMU context definition set 538 is read and provided to 539-1 the program instructions to operate on as shown at 546. The program instructions execute to combine the above described partial fractions and provide an output representing the BE register dependency fraction output 547 for the program instructions to operate on at 540 (discussed above) and 550 (discussed below).

As shown in FIG. 5B, the partial fraction of micro-architectural event counts measured with PMU context definition set 548 are read and provided to 549 the program instructions to operate on as shown at 550. The BE register dependency fraction output 547 and the Dcache fraction 523 are further provided to program instructions to operate on as shown at 550. In the embodiment of FIG. 5B the program instructions execute to combine the above described partial fractions and provide outputs representing the “D0TLB fraction” at 551, and the “D1TLB fraction” at 552.

FIG. 6 is a normalized graph illustrates cross correlation 602 of different measurements, with their respective number of different groups of micro-architecture events, and correlation between samples in real time. As shown FIG. 6, the resultant count reads from the various multiplexed PMU context definition sets, e.g., 502, 504, 508, 514, 518, 524, 530, 538, 544, and 548 are combined as partial fractions to provided insight to produce category fractions relating to the categories of scoreboard, data access (including D0TLB, D1TLB, DCACHE), instruction access (including ITLB and ICACHE), miss predicted branch, branch execution, RSE active, and unstalled execution, mentioned above. As mentioned above, the results can be applied to in real-time to the several components. The graph of FIG. 6 illustrates the results applied in real-time to obtain the CPI stall breakdown of the Gzip application, as the same will be recognized by one of ordinary skill in the art. As shown in FIG. 6, these results allow a user to easily identify performance limiters. These results can be cross correlated to other measurements (e.g., cache miss rates for each of the three levels, tlb miss rates for each of the two levels, etc.) to assist in identifying application characteristics that limit performance with the possibility of identifying code changes that would improve performance.

As the reader will appreciate, similar graphs can be displayed for other application (CPI) component breakdown measurement. That is, measurement and analysis for other processor performance components can be achieved according to the embodiments described herein. Embodiments are not limited to the examples given. The monitoring program application embodiments described herein thus provide data in far less time (sec/min versus hrs/days) without the user having an intimate micro-architecture knowledge and works additionally well for non-terminating commercial applications.

As the reader will appreciate, such insight would not be available without the selective combination of micro-architectural events into time division multiplexed groups configured according to a relationship decision tree. In other words, without a relationship decision tree relating groups of micro-architecture events together and calculating measurements upon the same based upon the decision tree, it would not be possible to realize meaningful information form the several hundreds and of micro-architectural events that may be measurable with a PMU and counting would be limited to the number of counters available hence not providing a real time performance picture.

Although specific embodiments have been illustrated and described herein, those of ordinary skill in the art will appreciate that an arrangement calculated to achieve the same techniques can be substituted for the specific embodiments shown. This disclosure is intended to cover adaptations or variations of various embodiments of the invention. It is to be understood that the above description has been made in an illustrative fashion, and not a restrictive one. Combination of the above embodiments, and other embodiments not specifically described herein will be apparent to those of skill in the art upon reviewing the above description. The scope of the various embodiments of the invention includes other applications in which the above structures and methods are used. Therefore, the scope of various embodiments of the invention should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the embodiments of the invention require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A method for monitoring a processor, comprising:
selectively combining micro-architectural events into various groups of micro-architectural events; and
multiplexing the various groups of micro-architectural events to a performance monitoring unit (PMU) associated with the processor.

2. The method of claim 1, wherein the method includes recording data from the various micro-architectural events.

3. The method of claim 2, wherein the method includes calculating metrics from the recorded data on the various micro-architectural events.

4. The method of claim 2, wherein the method includes calculating metrics on the recorded data by combining the various groups based upon particular relationship distribution trees.

5. The method of claim 1, wherein the method includes time division multiplexing the various groups of micro-architectural events to the PMU.

6. The method of claim 1, wherein the method includes event count multiplexing performed by counter overflow generated event switching.

7. A computer readable medium having executable instructions thereon for causing a device to perform a method, comprising:
selectively combining micro-architectural events into various groups of micro-architectural events;
multiplexing the various groups of micro-architectural events to a performance monitoring unit (PMU) associated with the processor;
recording data from the various micro-architectural events; and
calculating metrics on the recorded data by combining the various groups based upon particular relationship distribution trees.

8. The medium of claim 7, wherein the method includes generating performance metrics in real time.

9. The medium of claim 7, wherein the method includes multiplexing the various groups of micro-architectural events to a PMU having six or fewer counters.

10. The medium of claim 7, wherein the method includes calculating metrics to provide a prioritized accounting of reasons for execution stalls on the processor.

11. The medium of claim 7, wherein the method includes calculating metrics on the recorded data by combining the various groups based upon twenty two event relationship distribution trees.

12. The medium of claim 7, wherein the method includes selectively combining the groups of micro-architectural events into a number of PMU context definition sets associated with a particular measurement.

13. The medium of claim 12, wherein the method includes multiplexing the number of PMU context definition sets to the PMU based upon a particular relationship distribution tree.

14. A computing device, comprising:
a processor;
a memory in communication with the processor; and
program instructions storable in memory and executable on the processor to:
selectively combine micro-architectural events into various groups of micro-architectural events;
selectively combine the groups of micro-architectural events into a number of PMU context definition sets associated with a particular measurement; and
multiplex the number of PMU context definition sets associated with the particular measurement to a performance monitoring unit (PMU) associated with the processor.

15. The device of claim 14, wherein the program instructions can execute to multiplex the number of PMU context definition sets associated with the particular measurement to the PMU based upon a relationship distribution tree.

16. The device of claim 14, wherein the program instructions can execute to selectively combine the groups of micro-architectural events into a number of different PMU context definition sets associated with a number of different measurements.

17. The device of claim 16, wherein the program instructions can execute to multiplex the number of different PMU context definition sets associated with the number of different measurements to the PMU.

18. The device of claim 17, wherein the program instructions can execute to calculate metrics from recorded data on the number of different measurements based upon a number of different relationship distribution trees.

19. The device of claim 18, wherein the program instructions can execute to cross correlate calculated metrics on the number of different measurements.

20. The device of claim 19, wherein the program instructions can execute to cross correlate calculated metrics on the number of different measurement in real time while a non-terminating application is running on the device.

21. A computing device, comprising:
a processor;
a memory in communication with the processor; and
means for generating metrics of arbitrary complexity in real time using a number of micro-architectural event counts which is larger than a number of resources available in a performance monitoring unit (PMU).

22. The device of claim 21, wherein the means includes program instructions that can execute to:
selectively combine micro-architectural events into various groups of micro-architectural events; and
multiplex the various groups of micro-architectural events to a number of PMU configuration sets in the PMU according to a relationship distribution tree, the PMU sets having a number of counters and a number of qualification resources associated therewith.

23. The device of claim 22, where the means includes program instructions that can execute to:
record data from the counters; and
calculate metrics from recorded data by combining the various groups based upon the relationship distribution tree.

24. The device of claim 21, wherein the device is part of a wide area network.
